(19) United States
(12) Patent Application Publication
(10) Pub. No.: US 2024/0184147 A1
(43) Pub. Date: Jun. 6, 2024

(54) Wavelength Conversion Device And Manufacturing Method Of Wavelength Conversion Device

(71) Applicant: Nippon Telegraph and Telephone Corporation, Tokyo (JP)

(72) Inventors: Asuka Inoue, Musashino-shi, Tokyo (JP); Kei Watanabe, Musashino-shi, Tokyo (JP); Osamu Tadanaga, Musashino-shi, Tokyo (JP); Koji Embutsu, Musashino-shi, Tokyo (JP)

(21) Appl. No.: 18/554,590

(22) PCT Filed: May 24, 2021
(86) PCT No.: PCT/JP2021/019581

§ 371 Date: Oct. 9, 2023

(51) Int. Cl. G02F 1/01; G02F 1/00

(52) U.S. Cl. CPC G02F 1/0115; G02F 1/0027; G02F 1/0102

(57) ABSTRACT

Stress applied to a wavelength conversion element is relaxed at the time of temperature control of the wavelength conversion element, and stable operation and improvement of long-term reliability of a wavelength conversion device are realized. A wavelength conversion device includes: a wavelength conversion element that receives excitation light and signal light and outputs wavelength-converted output signal light; a temperature control element that controls a temperature of the wavelength conversion element; an upper member that is provided between the wavelength conversion element and the temperature control element and transfers heat between the temperature control element and the wavelength conversion element; and a sheet-like adhesive sheet provided between the wavelength conversion element (and the upper member. At least a part of the adhesive sheet has a surface facing the wavelength conversion element adhered to the wavelength conversion element, and a surface facing the upper member adhere to the upper member.

### TECHNICAL FIELD

The present disclosure relates to a wavelength conversion device and a method for manufacturing a wavelength conversion device.

### BACKGROUND ART

An optical element capable of generating and modulating coherent light over a wavelength band of ultraviolet light to visible light and terahertz is applied in various fields of optical communication systems. Examples of such fields include wavelength conversion, optical modulation, optical measurement, and optical processing of optical signals. Among them, it is known that an optical element using a nonlinear optical effect has excellent characteristics in wavelength conversion and an electro-optical effect. Examples of an optical material having a nonlinear optical effect and an electro-optical effect include oxide-based compound substrates such as lithium niobate (LiNbO₃: hereinafter also referred to as “LN”) and lithium tantalate (LiTaO₃: hereinafter also referred to as “LT”). Such an oxide-based compound substrate has a high second-order nonlinear optical constant and a high electro-optical constant, and is suitable for an optical material because it is transparent in a wide wavelength band.

Among LN and periodically poled lithium niobate (hereinafter also referred to as “PPLN”) and periodically poled lithium tantalate (hereinafter also referred to as “PPLT”) having a periodically poled structure are widely used. Note that the periodically poled structures of PPLN and PPLT are formed by taking advantage of the characteristic of being able to perform spontaneous polarization at room temperature. An optical material having a periodically poled structure has high phase matching, and as a result, has a high second-order nonlinear optical effect and the like. As an optical device using high nonlinearity of PPLN and PPLT, a wavelength conversion element using second-harmonic generation (hereinafter also referred to as “SHG”), difference frequency generation (hereinafter also referred to as “DFG”), and sum-frequency-generation (hereinafter also referred to as “SFG”) is known.

For example, in a wavelength range of 2 μm to 5 μm which is mid-infrared light, there are absorption bands caused by reference vibrations of various environmental gases represented by carbon dioxide. As one mid-infrared light source in which this absorption band is applied to optical measurement, there is a light source using difference frequency generation. For difference frequency generation, excitation light having a wavelength around 1 μm and an optical signal having a wavelength in a communication wavelength band are used. In addition, in a wavelength range of visible light having a wavelength around 500 nm, there is a wavelength range that is difficult to achieve with a semiconductor laser. In order to generate light in this wavelength range, development of a light source that generates excitation light having a wavelength around 1 μm and a wavelength conversion technology that can generate visible light by second-harmonic generation and sum-frequency-generation is desired.

Furthermore, for example, the wavelength conversion technology using DFG can collectively convert light having a wavelength band of 1.55 μm used in the optical communication system into another wavelength band. Such a wavelength conversion technology can realize optical routing in a wavelength division multiplexing system, collision avoidance of each wavelength in optical routing, and the like, and is therefore applied to constructing a large-capacity optical communication network.

In addition, the wavelength conversion technology using DFG includes signal distortion compensation using the fact that the conversion light becomes light having a phase conjugate with respect to the signal light. Signal distortion compensation is performed by converting signal light into phase-conjugate light at an intermediate propagating signal point of an optical transmission line and distortion generated by dispersion of optical fibers or a nonlinear optical effect in the optical transmission line before conversion to cancel each other in the optical transmission line after conversion. Therefore, the wavelength conversion technology is also used as a technology capable of reducing signal distortion caused by dispersion or a nonlinear optical effect in optical communication using an optical fiber.

In addition, a wavelength conversion element having high wavelength conversion efficiency can constitute an optical amplifier of signal light using optical parametric amplification caused by energy transfer from excitation light to signal light. In particular, a phase sensitive amplifier having an amplification characteristic according to a phase relationship between excitation light and signal light is desired to be developed as a low noise optical amplifier in which noise is not mixed in principle. Furthermore, in the field of quantum computing systems using light, it has been reported that it is possible to solve a specific problem faster than a conventional von Neumann computer by inserting an optical waveguide that performs optical parametric oscillation, which is one nonlinear optical effect, into a fiber ring resonator.

In order to further improve the performance of the technology applied to the above application examples, it is important to realize a wavelength conversion device having higher wavelength conversion efficiency and maintaining long-term reliability. In order to realize such a wavelength conversion device, it is essential to develop a nonlinear optical element having high wavelength conversion efficiency. Examples of such a candidate material include PPLN. In order to improve the efficiency of wavelength conversion of a wavelength conversion element using PPLN, an optical waveguide type optical device is promising. This is because the wavelength conversion efficiency is proportional to the power density of light propagating through a nonlinear medium, and the optical waveguide type optical device can confine the light in a limited region due to the optical waveguide structure.

As described above, an oxide-based compound material substrate such as LN or LT has a large electro-optical constant in addition to a second-order nonlinear optical constant, and is widely used as an optical modulator using an electro-optical effect. As an optical waveguide type optical device, a device using a diffusion type optical waveguide represented by a titanium diffusion waveguide has been commercialized. However, such devices have a problem that it is difficult to input light with high power resistance, and in order to solve this problem, a ridge type optical waveguide is being studied. The ridge type optical waveguide is described in, for example, Non Patent Literature 1, and has features such as high resistance to optical damage, long-term reliability, and ease of device design. In particular, a ridge type optical waveguide formed by a direct bonding method enables high power optical input, and is expected to be applied to generation of a light modulation signal with high light intensity, a laser processing technology, and the like.

The ridge type optical waveguide structure has a structure in which a core is sandwiched between two cladding layers. This structure is formed by thinning one substrate of a different-material bonded substrate formed by bonding two substrates having different refractive indexes, then performing ridge processing, and further forming an overcladding layer.

In addition, in general, the refractive index of the nonlinear optical material has temperature dependency. In particular, when it is necessary to strictly satisfy the pseudo transfer matching condition, it is necessary to keep the temperature of the wavelength conversion element constant. Therefore, the wavelength conversion element, which is a nonlinear optical element, is usually installed together with a temperature detector such as a thermistor or a thermocouple, and the temperature is monitored by measuring the resistance value thereof. A temperature control unit such as a heater or a Peltier element performs feedback control on the basis of the measured temperature to keep the operating wavelength conversion element at a constant temperature.

In addition, when a wavelength conversion element using a ferroelectric crystal material such as PPLN is used for wavelength conversion, the refractive index inside the wavelength conversion element changes due to irradiation with light having a short wavelength, and a phenomenon called optical damage in which characteristics deteriorate occurs. As a method for suppressing the influence of optical damage on the characteristics, a method of operating a wavelength conversion element at a high temperature is known, and a method using a temperature control unit for realizing a high-temperature operation has also been proposed. As described above, a technology for stably operating the wavelength conversion element at an arbitrary temperature, particularly at a high temperature is important from the viewpoint of improving the efficiency of wavelength conversion and ensuring long-term reliability.

When the wavelength conversion circuit including the ridge type optical waveguide described above is actually used, in order to prevent characteristics from deteriorating due to a change in use environment represented by a change in outside air temperature or external pressure, a method of storing a wavelength conversion element and using it together with a multiplexer and a demultiplexer for multiplexing and demultiplexing input light and output light of light in a metal housing including an input/output port capable of inputting and outputting light is known. In addition, in such a configuration, in order to maximize wavelength conversion efficiency by controlling the temperature of the wavelength conversion element, there is a wavelength conversion device including a temperature control element in a metal housing. Such a wavelength conversion device is described in Patent Literature 1, for example.

The wavelength conversion device described in Patent Literature 1 includes a wavelength conversion element, a multiplexer that multiplexes signal light input to the wavelength conversion element and excitation light, a demultiplexer that demultiplexes the signal light and the excitation light wavelength-changed by the wavelength conversion element, a temperature control element, an upper member provided between the temperature control element and the wavelength conversion element, and a metal housing that seals the above configuration. The upper member is a metal member for uniformly controlling the entire temperature of the wavelength conversion element. Patent Literature 1 describes that the linear expansion coefficients of the upper member and the bottom member are preferably substantially equal to the linear expansion coefficient of the temperature control element in order to suppress deformation of the upper member and the bottom member of the metal housing due to thermal stress generated by a temperature change of the temperature control element.

### CITATION LIST

### Patent Literature

Patent Literature 1: JP 2020-86031 A

### Non Patent Literature

Non Patent Literature 1: S. Kurimura, Y. Kato, M. Maruyama, Y. Usui, and H. Nakajima, “Quasi-Phase-Matched adhered ridge waveguide in LiNbO3,” Appl. Phys. Lett. 89, 191123 (2006)

### SUMMARY OF INVENTION

FIG. 7 is a view for describing deformation due to thermal stress in a wavelength conversion device. The wavelength conversion device illustrated in FIG. 7 includes a wavelength conversion element 330 including an optical waveguide core 310, an overcladding layer 340, and a substrate 320, an upper member 270, a temperature control element 260, and a metal housing 290 that seals the above configuration. The temperature control element 260 is provided on an upper surface of a bottom member 280 of the metal housing 290. Note that, in the coordinate system illustrated in FIG. 7, a direction in which signal light (not illustrated) is input to the wavelength conversion element 330 is an x axis, and a side having a larger coordinate of a z axis is set to “upper” than a side having a smaller coordinate. The upper member 270 and the bottom member 280 are deformed by receiving thermal stress due to heat generated by the temperature control element 260. Therefore, in a known technology, the thermal expansion coefficients of the bottom member 280 and the upper member 270 are set to be substantially equal to the thermal expansion coefficient of the temperature control element 260, thereby suppressing deformation of the upper member 270 and the bottom member 280 due to thermal stress.

In the known configuration illustrated in FIG. 7, the temperature control element 260 is interposed between the upper member 270 and the bottom member 280. The temperature control element 260 is, for example, a Peltier element, and is bonded by solder bonding, silver paste, or a conductive adhesive such as a resin-based material in order to efficiently transfer heat generation and heat absorption effects to the upper member 270 and the bottom member 280.

The above bonding has two problems. One of them is warpage of the structure caused by a difference in thermal expansion coefficient between the upper member 270 and the wavelength conversion element 330. This warpage can be suppressed by setting the thermal expansion coefficients of the upper member 270 and the wavelength conversion element 330 to be as equal as possible by selecting materials of the upper member and the wavelength conversion element. However, it is difficult to select a material having a thermal expansion coefficient equal to that of the wavelength conversion element 330 while having a high thermal conductivity, and there is a difference in thermal expansion coefficient between the upper member 270 and the wavelength conversion element 330.

When the upper member 270 and the wavelength conversion element 330 having different thermal expansion coefficients are adhered to each other, it is conceivable that warpage occurs in a structure in which the upper member 270 and the wavelength conversion element 330 are bonded (hereinafter referred to as a “bonding structure”) due to a difference in thermal expansion coefficient between the upper member and the wavelength conversion element at the time of temperature control, particularly at the time of high-temperature operation. When the upper member 270 and the wavelength conversion element 330 are adhered with a conductive adhesive made of a metal such as solder or silver paste, since an elastic modulus of the conductive adhesive is relatively large, the conductive adhesive is deformed following the warpage of the bonding structure, and the warpage cannot be suppressed. The warpage of the bonding structure causes an increase in insertion loss due to optical axis deviation of the wavelength conversion device, temperature control operation failure due to bonding failure with the temperature control element 260, and deterioration of optical characteristics such as stress distortion of the wavelength conversion element 330. Such deterioration of optical characteristics finally leads to deterioration of long-term reliability of the wavelength conversion device.

Another problem is uneven application of the conductive adhesive. That is, since the solder, the silver paste, and the resin-based conductive adhesive mainly take a liquid form, not a little uneven application exists in the applied layer. Uneven application generates in-plane distribution of thermal conductivity, and prevents the control temperature in the wavelength conversion element from being uniform. In addition, the uneven application makes it difficult to horizontally fix the wavelength conversion element 330, and causes deterioration in characteristics of the wavelength conversion device.

The present disclosure has been made in view of the above points, and an object of the present disclosure is to relax stress applied to a wavelength conversion element at the time of temperature control of the wavelength conversion element, to make a control temperature uniform, and to realize stable operation and improvement of long-term reliability of a wavelength conversion device.

In order to achieve the above object, according to an aspect of the present invention, there is provided a wavelength conversion device including: a wavelength conversion element that receives excitation light and signal light and outputs wavelength-converted conversion output signal light; a temperature control unit that controls a temperature of the wavelength conversion element; a heat transfer member that is provided between the wavelength conversion element and the temperature control unit and transfers heat between the temperature control unit and the wavelength conversion element; and a sheet-like resin layer provided between the wavelength conversion element and the heat transfer member, in which at least a part of the sheet-like resin layer has a surface facing the wavelength conversion element adhered to the wavelength conversion element, and a surface facing the heat transfer member adhere to the heat transfer member.

According to another aspect of the present invention, there is provided a method for manufacturing a wavelength conversion device including a wavelength conversion element, the method including: a step of inserting a sheet-like resin layer between the wavelength conversion element and a heat transfer member that transfers heat of a temperature control unit that controls a temperature of the wavelength conversion element to the wavelength conversion element; a step of pressurizing and curing the sheet-like resin layer to adhere the wavelength conversion element and the heat transfer member to each other; a step of housing the wavelength conversion element and the heat transfer member adhered to each other in a housing that is partially open, and inserting the temperature control unit between a bottom member of the housing and the heat transfer member; and a step of sealing an opening portion of the housing.

According to the above aspects, it is possible to relax stress applied to a wavelength conversion element at the time of temperature control of the wavelength conversion element, to make a control temperature uniform, and to realize stable operation and improvement of long-term reliability of a wavelength conversion device.

### BRIEF DESCRIPTION OF DRAWINGS

FIG. 1 (a) is a schematic view illustrating warpage at the time of high-temperature operation in a conventional wavelength conversion device, and FIG. 1(b) is a schematic view illustrating a structure for eliminating warpage in a wavelength conversion device of an embodiment of the present invention.

FIG. 2 is a schematic perspective view for describing a wavelength conversion device of a first embodiment of the present invention.

FIG. 3 is a schematic exploded perspective view of a part of the wavelength conversion device illustrated in FIG. 2.

FIG. 4 (a) is a schematic cross-sectional view of a part of the wavelength conversion device of the first embodiment taken along a y-z plane in the drawing. FIG. 4(b) is a schematic cross-sectional view of a part of the wavelength conversion device of the first embodiment taken along an x-z plane in the drawing.

FIGS. 5 (a), 5 (b), and 5 (c) are views for describing a method for manufacturing a wavelength conversion element.

FIG. 6 (a) is a schematic cross-sectional view of a part of a wavelength conversion device of a second embodiment taken along a y-z plane in the drawing. FIG. 6 (b) is a schematic cross-sectional view of a part of the wavelength conversion device of the second embodiment taken along an x-z plane in the drawing.

FIG. 7 is a view for describing deformation due to thermal stress in a wavelength conversion device.

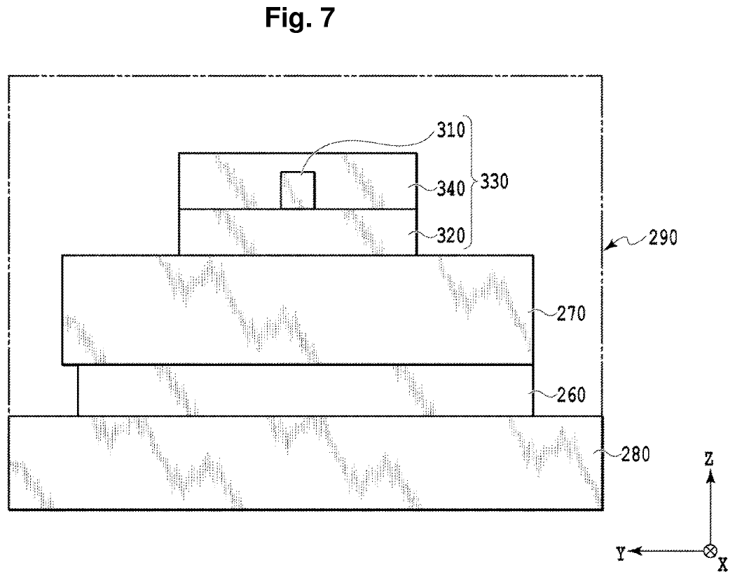

### DESCRIPTION OF EMBODIMENTS

A first embodiment and a second embodiment (hereinafter, the first embodiment and the second embodiment are also collectively referred to as “the present embodiment”) of the present invention will be described below. In the drawings used for the description of the present embodiment, the same members are denoted by the same reference numerals, and the description thereof may be partially omitted. In addition, the drawings are schematic views for describing the shape and configuration of the wavelength conversion device of the present embodiment, the positional relationship of each part of the configuration, and the technical idea, and are not limited to those accurately indicating the specific shape and size, and the length, width, thickness, and the like.

### Overview

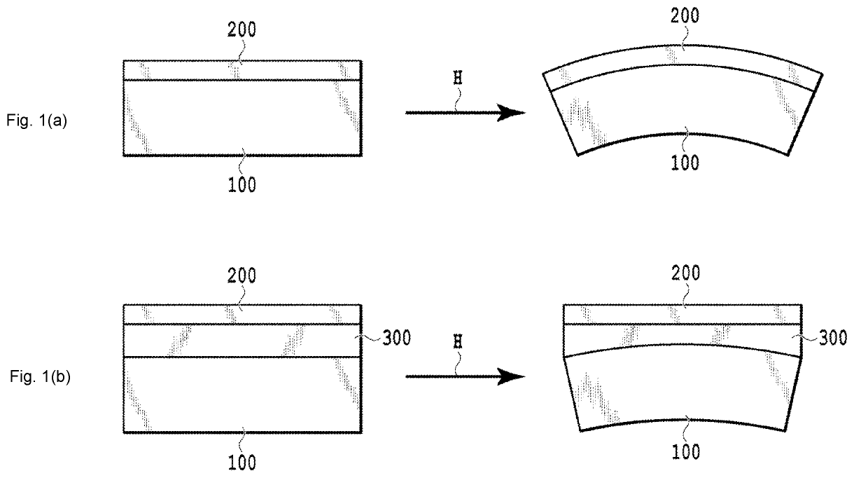

FIGS. 1 (a) and 1 (b) are views for describing an overview of the present embodiment. FIG. 1 (a) is a schematic view illustrating warpage at the time of high-temperature operation in a conventional wavelength conversion device, and FIG. 1(b) is a schematic view illustrating a structure for eliminating warpage in a wavelength conversion device of the present embodiment. Also in the wavelength conversion device in either of FIGS. 1 (a) and 1 (b), a temperature control element such as a Peltier element and a wavelength conversion element 200 are bonded via an upper member 100 provided for heat conduction. In the conventional wavelength conversion device of FIG. 1 (a), the wavelength conversion element 200 and the upper member 100 are adhered with a conductive adhesive. In the wavelength conversion device of FIG. 1 (b), the wavelength conversion element 200 and the upper member 100 are adhered to each other by an adhesive sheet 300 including a sheet or a film-like resin layer instead of bonding the wavelength conversion element and the upper member with a conductive adhesive. The adhesive sheet 300 has an elastic modulus smaller than that of solder or silver paste, is flatter than a conductive adhesive made of a resin, and has a thickness that provides rigidity sufficient for relaxing deformation of the upper member 100. Here, both the sheet and the film refer to a member that is relatively thin and uniform in thickness, and do not define the thickness and flatness thereof.

As illustrated in FIG. 1 (a), when the wavelength conversion element 200 is adhered to the upper member 100 with a conductive adhesive and the temperature control element is operated under a condition that the environmental temperature of the wavelength conversion element is a high temperature of 600° C. or higher, for example, the wavelength conversion element 200 and the upper member 100 are heated by heat H generated by the temperature control element and expand at different magnifications. At this time, the conductive adhesive is deformed following the stress generated by the difference in expansion magnification, and warpage occurs in the bonding structure obtained by bonding the wavelength conversion element 200 and the upper member 100. On the other hand, in the bonding structure illustrated in FIG. 1 (b), the adhesive sheet 300 is inserted between the wavelength conversion element 200 and the upper member 100. The adhesive sheet 300 has an elastic modulus smaller than that of solder or silver paste, and can have a thickness larger than that of a liquid conductive adhesive using a resin and can be kept uniform. Such an adhesive sheet 300 has higher rigidity than that of the liquid conductive adhesive, and can relax deformation of the upper member 100, suppress stress applied to the wavelength conversion element 200, and suppress warpage of the bonding structure.

In addition, since the adhesive sheet 300 can make the in-plane distribution of the thickness equal to or less than the uneven application of the adhesive, the in-plane distribution of the thermal conductivity can be made smaller and the control temperature applied to the wavelength conversion element 200 can be made uniform compared to when the wavelength conversion element 200 is adhered to the upper member 100 by applying the liquid conductive adhesive. Further, the adhesive sheet 300 having a uniform thickness can easily fix the wavelength conversion element 200 horizontally to the upper member 100. Hereinafter, the wavelength conversion device of the present embodiment will be specifically described.

### First Embodiment

### (Wavelength Conversion Device)

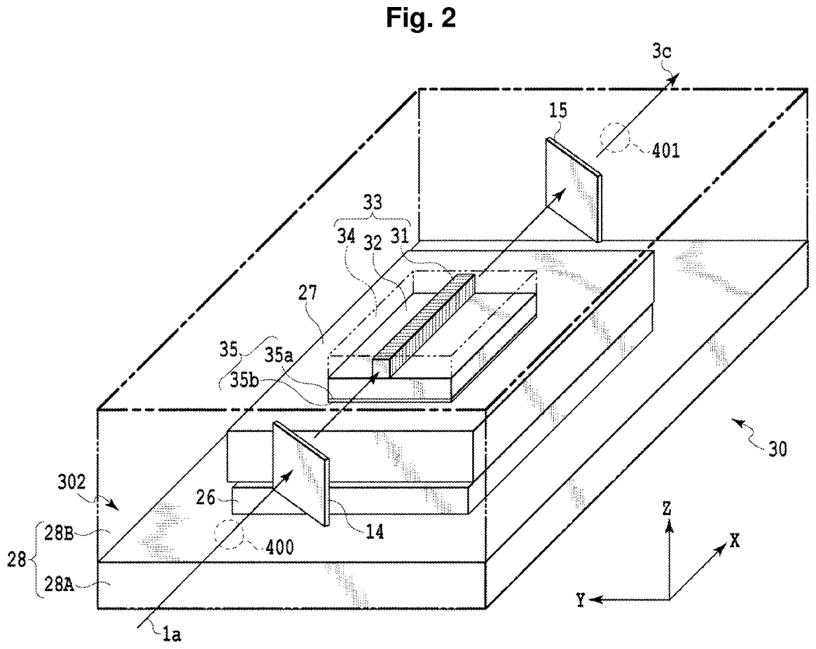

FIG. 2 is a schematic perspective view for describing a wavelength conversion device 30 of a first embodiment. The wavelength conversion device 30 includes a metal housing 28, a multiplexer 14 that multiplexes signal light 1a input to a wavelength conversion element 33 provided inside the metal housing 28 and excitation light (not illustrated), and a demultiplexer 15 that demultiplexes conversion output signal light 3c wavelength-converted by the wavelength conversion element 33 and excitation light (not illustrated). The signal light 1a is a fundamental wave having a wavelength of 1550 nm, and the conversion output signal light 3c is signal light having a wavelength of 775 nm which is a second harmonic of the fundamental wave.

The metal housing 28 includes a bottom member 28A and a cover member 28B provided on the bottom member 28A. The wavelength conversion element 33 including an optical waveguide core 31, a substrate 32, and an overcladding layer 34, a temperature control element 26, an upper member 27, and a sheet-like resin layer provided between the substrate 32 of the wavelength conversion element 33 and the upper member 27 are provided on the bottom member 28A. In the first embodiment, a sheet-like resin layer is formed of a material having adhesiveness, and the wavelength conversion element 33 and the upper member 27 are adhered to each other by the sheet-like resin layer. In such a first embodiment, the sheet-like adhesive layer is used as an adhesive sheet 35.

The temperature control element 26 of the first embodiment is, for example, a Peltier element, and generates heat on a surface facing the wavelength conversion element 33 and absorbs heat on a surface facing the bottom member 28A. The amount of heat generated and the amount of heat absorbed are controlled by the current supplied to the temperature control element 26. The upper member 27 is located between the wavelength conversion element 33 and the temperature control element 26 and functions as a heat transfer member that transfers heat generated by the temperature control element 26 to the wavelength conversion element 33. The material of the upper member 27 preferably contains one or more metals selected from stainless steel, copper molybdenum steel, carbon steel, chromium molybdenum steel, copper, phosphorus-deoxidized copper, oxygen-free copper, phosphor bronze, or brass. In the first embodiment, oxygen-free copper is used as the upper member 27.

The bottom member 28A and the cover member 28B are bonded to seal the above configuration. The cover member 28B includes an input port 400 for inputting the signal light 1a and an output port 401 for outputting the conversion output signal light 3c. Note that, in FIG. 2, the upper and lower sides are determined according to the coordinate system illustrated in FIG. 2, and the larger side of the z coordinate is set to “upper” or “above” than the smaller side of the z coordinate.

Optical fibers (not illustrated) connect between the optical waveguide core 31 and the input port 400 and between the output port 401 and the optical waveguide core 31, respectively. In the first embodiment, the demultiplexer 15 provided between the optical waveguide core 31 and the optical fiber on the output port 401 side may reflect excitation light (not illustrated) and transmit the conversion output signal light 3c. In the first embodiment, the demultiplexer 15 on the output port 401 side may transmit excitation light and reflect the conversion output signal light 3c, and the reflected light may be optically connected to the optical fiber on the output port 401 side. According to such a configuration, it is possible to extract only the component of the conversion output signal light 3c whose wavelength has been converted from the component of the light guided and output by the optical waveguide core 31 and to reduce noise of the light output from the optical waveguide core 31. In the first embodiment, a 45-degree mirror is used as the demultiplexer 15. The demultiplexer 15 functions as a selective transmission/reflection unit in the first embodiment.

The bottom member 28A is preferably a member having high mechanical strength. The material of the bottom member 28A preferably contains one or selected from tungsten, molybdenum, kovar, copper tungsten steel, stainless steel, or copper molybdenum steel. In the first embodiment, stainless steel is used as the bottom member 28A. A dry gas 302 is sealed in the metal housing 28 in order to prevent dew condensation at the time of temperature control. Here, the inside of the metal housing 28 is an atmosphere around the wavelength conversion element 33, the temperature control element 26, the upper member 27, and the bottom member 28A sealed in the metal housing 28. The dry gas 302 desirably contains one or more selected from nitrogen, oxygen, argon, and helium. In the first embodiment, nitrogen gas is used as the dry gas 302.

The optical waveguide core 31 is an optical waveguide that selectively transmits the inside of the signal light 1a without losing the intensity of the signal light 1a. The wavelength conversion element 33 including the optical waveguide core 31 is an optical waveguide type wavelength conversion element. The structure of the optical waveguide core 31 is not particularly limited as long as it has a function of outputting the wavelength-converted conversion output signal light 3c having a wavelength different from that of the signal light 1a when the wavelength of the signal light 1a is input. The structure of the optical waveguide core 31 can also employ, for example, a multi quasi phase matching (QPM) element having a structure in which a second-order nonlinear constant changes periodically along a traveling direction of light or at a cycle to which predetermined modulation is applied, and pseudo phase matching is realized for a single wavelength or a plurality of wavelengths. In addition, in the first embodiment, the size of the optical waveguide core 31 is not particularly limited, and may be a relatively large core diameter (10 μm) or more through which light propagates in a multimode, or may be a small core diameter (10 μm) or less through which light propagates in a single mode. Further, the optical waveguide may be an optical waveguide in which the core layer is thinned by a smart cut method or the like to attempt to reduce the core, and the core diameter may be a very small core diameter (nm unit). In addition, the core shape is not particularly limited, and may be any shape as long as it is a square, a rectangle, a trapezoid, or any other shape that can be processed.

The substrate 32 is a ferroelectric substrate that is transparent to the signal light 1a, that is, does not absorb light. The substrate 32 functions as an undercladding layer for the optical waveguide core 31 when constituting the ridge type optical waveguide, and needs to have a refractive index lower than that of the optical waveguide core 31 with respect to the signal light 1a, excitation light (not illustrated), and the wavelength-converted conversion output signal light 3c. As the ferroelectric material to be employed for the substrate 32, LiNbO₃, KNbO₃ (potassium niobate), LiTaO₃ (lithium tantalate), LiNb(ₓ)Ta(₁₋ₓ)O₃ (0≤x≤1) (lithium tantalate having a non-stoichiometric composition), or KTiOPO₄ (potassium phosphate titanate), and those containing at least one selected from Mg (magnesium), Zn (zinc), Sc (scandium), and In (indium) as an additive are preferable.

The overcladding layer 34 may be made of a material similar to that of the substrate 32 which is an undercladding layer. The overcladding layer 34 may be air (air cladding), glass deposited by a chemical vapor deposition (CVD) method, a flame hydrolysis deposition (FHD) method, or a sputtering method, or the like. Furthermore, the refractive index of the overcladding layer 34 is not particularly limited, and the size may be any size as long as the design of the optical waveguide structure has a dimensional shape. Furthermore, the overcladding layer 34 may be formed as necessary.

As described above, in the first embodiment, the wavelength conversion element 33 of the ridge type optical waveguide in which the core layer serving as the optical waveguide core 31 by direct bonding and the substrate 32 (undercladding layer) are bonded is targeted. That is, the wavelength conversion element 33 has a structure including an undercladding layer, an overcladding layer, and a core layer, and has an optical waveguide structure in which light propagates inside the core layer. Since the undercladding layer and the core layer are bonded by direct bonding and thus have high resistance to optical damage, it is possible to input excitation light having a very high power density into the optical waveguide.

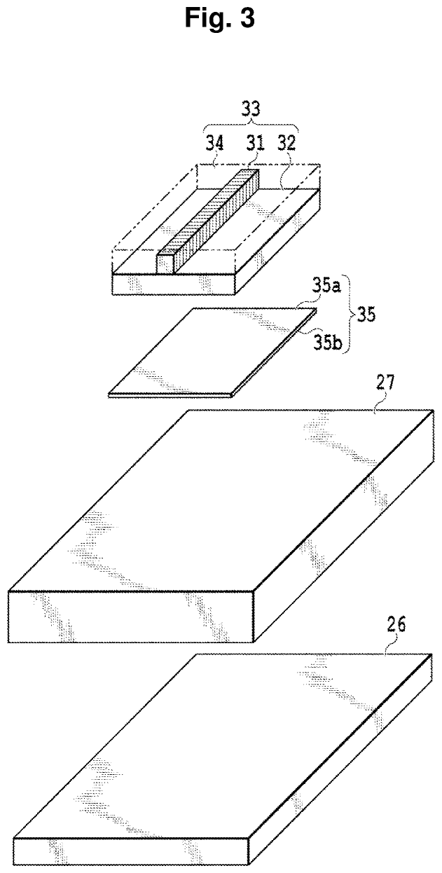

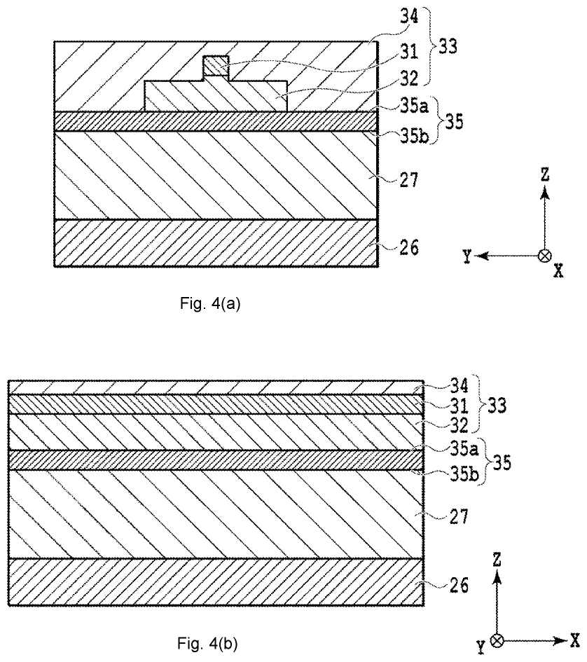

FIG. 3 is a schematic exploded perspective view of the wavelength conversion element 33, the adhesive sheet 35, the upper member 27, and the temperature control element 26 illustrated in FIG. 2. FIG. 4 (a) is a schematic cross-sectional view of the wavelength conversion element 33, the adhesive sheet 35, the upper member 27, and the temperature control element 26 illustrated in FIG. 2 taken along a y-z plane in the drawing. FIG. 4 (b) is a schematic cross-sectional view of the wavelength conversion element 33, the adhesive sheet 35, the upper member 27, and the temperature control element 26 illustrated in FIG. 2 taken along an x-z plane. As illustrated in FIGS. 3, 4 (a), and 4(b), the adhesive sheet 35 of the first embodiment is provided on the entire surface between the wavelength conversion element 33 and the upper member 27. In the first embodiment, the adhesive sheet 35 is a sheet of an adhesive produced from a material containing at least one of an epoxy resin and a polyimide resin. Such an adhesive sheet 35 also functions as an adhesive for bonding the substrate 32 of the wavelength conversion element 33 and the upper member 27.

That is, in the first embodiment, a surface 35a of the adhesive sheet 35 facing the wavelength conversion element 33 adheres to the wavelength conversion element 33, and a surface 35b of the adhesive sheet 35 facing the upper member 27 adheres to the upper member 27. Such a configuration is not limited to the configuration over the entire surface of the adhesive sheet 35, and may be a part of the adhesive sheet 35. That is, in the first embodiment, the lower surface of the substrate 32 of the wavelength conversion element 33 and the upper surface of the upper member 27 are connected via the adhesive sheet 35, and there are at least some parts that are not in direct contact. However, as a matter of course, in the adhesive sheet 35, the range in which the surface 35a adheres to the wavelength conversion element 33 and the surface 35b adheres to the upper member 27 satisfies the range that exhibits the effect of relaxing the deformation of the upper member 27.

The adhesive sheet 35 of the first embodiment may be any sheet as long as it can obtain elasticity necessary for relaxing the stress applied to the wavelength conversion element by the upper member 27 and efficiently conduct the heat from the temperature control element 26 to the substrate 32. In particular, the thickness of the adhesive sheet 35 may be any thickness as long as the thickness fits within the metal housing and does not interfere with other members. From the viewpoint of flatness and suppression of warpage of the bonding structure, the thickness of the adhesive sheet 35 of the first embodiment is preferably, for example, 10 μm or more and 200 μm or less.

As described above, the adhesive sheet 35 of the first embodiment is not limited to one made of at least one of an epoxy resin and a polyimide resin, and any material may be used as long as the elastic modulus, the thermal conductivity, and the rigidity satisfy the required performance. In the first embodiment, a thermosetting resin is used for the adhesive sheet 35, but the present invention is not limited thereto, and a material that is cured by any method may be used as long as the method does not affect the wavelength conversion element 33 and the upper member 27. Examples of such a curing method include a photocuring method.

The adhesive sheet 35 mainly contains a curing agent, an elastomer, a filler, a curing accelerator, a coupling agent, and the like in addition to an epoxy resin or a polyimide resin. The adhesive sheet 35 is prepared by mixing such materials to form a layer of an adhesive composition on a support film, and heating and drying the layer to bring the layer into a semi-cured state. Examples of the support film include films of polytetrafluoroethylene, polyethylene, polypropylene, polymethylpentene, polyethylene terephthalate, polyimide, and the like. The thickness of the support film may be, for example, about 10 μm to 200 μm. In the first embodiment, the adhesive composition may be applied to a support film by a known method to prepare the adhesive sheet 35, and as the application method, for example, a knife coating method, a roll coating method, a spray coating method, a gravure coating method, a bar coating method, a curtain coating method, or the like may be used. The heating and drying conditions are not particularly limited as long as the used solvent is sufficiently volatilized. After the surfaces 35a and 35b of the adhesive sheet 35 are attached to the substrate 32 of the wavelength conversion element 33 and the upper member 27, the adhesive sheet 35 is further heated to change from a semi-cured state to a fully cured state.

As described above, the adhesive sheet 35 of the first embodiment is an adhesive that is attached to the wavelength conversion element 33 and the upper member 27, and has an excellent stress relaxation property caused by an elastic modulus smaller than that of solder or silver paste, and thus is an optimal adhesive for adhering different types of materials having different thermal expansion coefficients. In addition, since the adhesive sheet 35 is very flat due to the characteristics of the sheet or the film, it is possible to realize a flatter adhesive layer than the applied liquid adhesive. In addition, since the adhesive sheet 35 is made of a resin-based material, the adhesive sheet has relatively good elongation, is easily embedded in fine irregularities of the substrate 32 of the wavelength conversion element 33 and the upper member 27, and can increase an adhesion area. With such an action, it is possible to increase an adhesive force and thermal conductivity to the substrate 32 and the upper member 27.

Further, in the adhesive sheet 35, the surfaces 35a and 35b adhere to the substrate 32 or the upper member 27, and a thickness between the surfaces 35a and 35b can be ensured. Therefore, the adhesive sheet 35 has higher rigidity than a liquid adhesive made of a similar resin, and can relax the deformation of the upper member 27 to reduce the warpage of the bonding structure with the wavelength conversion element 33. Such a wavelength conversion device 30 of the first embodiment can relax stress applied to the wavelength conversion element at the time of temperature control of the wavelength conversion element, and can realize stable operation and improvement of long-term reliability.

Furthermore, in the first embodiment, the elastic modulus and the thermal expansion coefficient of the adhesive sheet 35 after curing can be adjusted by adjusting another material such as an epoxy resin. At this time, when the elastic modulus of the adhesive sheet 35 is made smaller than the elastic modulus of a liquid adhesive made of a similar resin, the warpage of the bonding structure between the substrate 32 and the upper member 27 can be further relaxed. Furthermore, for example, it is preferable to adjust the mixing amount of the filler to bring the thermal expansion coefficient of the adhesive sheet 35 close to the thermal expansion coefficients of the substrate 32 and the upper member 27. By using the sheet-like adhesive sheet 35 having an elastic modulus smaller than that of a known adhesive material and having a flat structure, stress applied to the wavelength conversion element is relaxed, and at the same time, a temperature (control temperature) applied to the wavelength conversion element 33 is made uniform, and the wavelength conversion element 33 and the upper member 27 can be flatly adhered to each other. With such a configuration, a wavelength conversion device having high optical characteristics and long-term reliability can be realized as compared to a known wavelength conversion device.

### (Method for Manufacturing Wavelength Conversion Device)

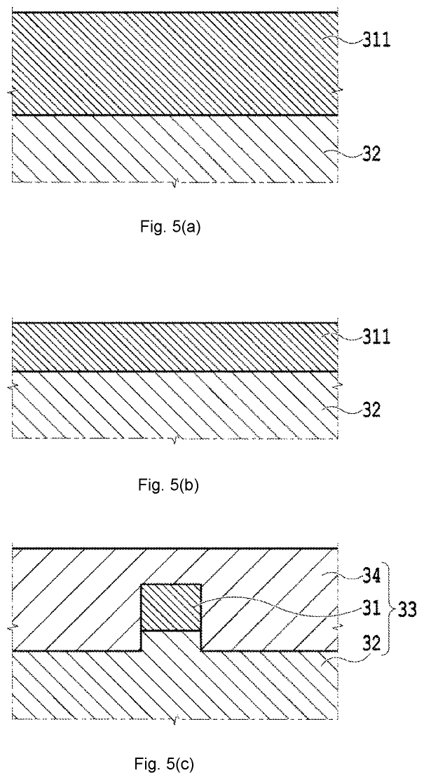

Next, a method for manufacturing the above-described wavelength conversion device will be described. A method for manufacturing the wavelength conversion device of the first embodiment to be described with reference to FIG. 5 includes a step of bonding the substrate 32 serving as an undercladding layer and a core substrate 311 serving as the optical waveguide core 31, a step of thinning the core substrate 311, a step of processing the core substrate 311 to form an optical waveguide, a step of dividing the substrate 32 and the core substrate 311 to chip the wavelength conversion element 33, and a step of attaching the wavelength conversion element 33 to the upper member 27 with the adhesive sheet 35 interposed therebetween. Such steps will be sequentially described below.

### (Substrate Bonding Step)

FIGS. 5 (a), 5 (b), and 5 (c) are views for describing a method for manufacturing the wavelength conversion element 33 having a ridge type optical waveguide. In the first embodiment, as illustrated in FIG. 5 (a), the substrate 32 and the core substrate 311 which is a substrate serving as a core layer are bonded by direct bonding. The core substrate 311 is a substrate of a nonlinear optical material. The direct bonding is a bonding technology that does not use an adhesive, and can improve resistance to optical loss when high-intensity light is input. In the bonding step, by selecting a substrate having a thermal expansion coefficient as close as possible to that of the substrate 32 and the core substrate 311, it is possible to suppress cracking of the substrate 32 in the subsequent heat treatment process.

The direct bonding is a method in which the substrate 32 and the core substrate 311 are surface-treated using a chemical agent, then the substrate 32 and the core substrate 311 are superimposed on each other, and the substrate 32 and the core substrate 311 are bonded using an attractive force between the surfaces. The surface treatment is performed by optimizing conditions such as a temperature and a type of a chemical agent according to the type or combination of the substrate 32 and the core substrate 311 to be bonded. In addition, the bonding of the substrate 32 and the core substrate 311 needs to be performed in a clean atmosphere in which microparticles are minimally present. In addition, although direct bonding is performed at room temperature, since the bonding strength at this time is small, it is necessary to perform heat treatment at a high temperature thereafter, perform diffusion bonding, and improve the bonding strength. The bonded substrate 32 and core substrate 311 are void-free without interposing microparticles or the like on the bonding surface, and do not generate cracks or the like in a room temperature state. Direct bonding capable of firmly bonding substrates to each other without using an adhesive or the like has features such as high resistance to optical damage, long-term reliability, and ease of device design, and in this study, this leads to characteristic stabilization of the three-dimensional optical waveguide in the vicinity of the interface. In addition, there is also an advantage that contamination of impurities and absorption of an adhesive or the like can be avoided in light generation in the mid-infrared region using difference frequency generation, which is a type of nonlinear optical effect.

### (Thinning Step)

The core substrate 311 bonded to the substrate 32 is thinned as illustrated in FIG. 5(b). The thinning step of the first embodiment is not particularly limited in terms of a thinning method, and thinning by grinding or polishing or thinning by smart cut may be used. In thinning by grinding or polishing, a grinding/polishing process is performed using a device in which flatness of a surface plate for grinding/polishing is managed until an optical waveguide is present at an arbitrary depth. A polishing process is performed after completion of the grinding/polishing step, whereby a polished surface (optical end surface) of a mirror surface can be obtained. Finally, the parallelism of the substrate (the difference between the maximum height and the minimum height of the substrate) is measured using an optical parallelism measuring instrument, whereby the parallelism of the entire substrate can be obtained.

The thinning step by the smart cut mainly includes two steps of an ion implantation step and a thin film peeling step. In the ion implantation step, helium or hydrogen ions are implanted into a substrate that needs to be thinned having a second-order nonlinear optical effect. Ions are implanted from the surface of the core substrate 311 under a controlled acceleration voltage and a controlled dose amount and trapped at a certain depth from the surface. Ions to be used are desirably smaller than atoms constituting the core substrate 311, such as hydrogen and helium. The substrate peeling step is a step of heat-treating the core substrate 311 into which the ions are implanted, and peeling the core substrate 311 with the damaged layer in the core substrate 311 as a boundary. When the nonlinear optical material has a periodically poled structure, the heat treatment temperature in the substrate peeling step is equal to or less than the Curie temperature of the second-order nonlinear optical crystal so as not to destroy the patterned polarization direction.

### (Optical Waveguide Forming Step)

Next, in the first embodiment, as illustrated in FIG. 5 (c), the thinned core substrate 311 is processed to form the optical waveguide core 31. The method for forming the optical waveguide is not particularly limited, and a known method such as a dry etching process or cutting out the optical waveguide with a dicing saw may be used. The formation of the optical waveguide core 31 by dry etching is performed by etching the surface of the core substrate 311 using a dry etching apparatus. At this time, a resist pattern of the optical waveguide is formed on the surface of the core substrate 311 by a known photolithography process. The optical waveguide is formed by dry etching using the formed resist pattern as a mask.

The optical waveguide core 31 is formed by machining such as a dicing saw using, for example, a dicing blade used in a known dicing process. In the dicing process, the accuracy of the structure of the optical waveguide core 31 to be manufactured is determined mainly by the accuracy of a machine used for processing, in particular, the positional accuracy of a stage or a processing portion for fixing a sample. Further, in the first embodiment, as illustrated in FIG. 5 (c), a glass layer serving as the overcladding layer 34 is deposited on the optical waveguide core 31.

Next, in the first embodiment, the configuration manufactured by the above steps is divided. Each of the divided substrate 32 and core substrate 311 is chipped to be a one-chip wavelength conversion element 33. Chipping may be performed using a dicing saw, but a processing method is not particularly limited. In addition, by optically polishing the end surface of the chip after chipping or coating the chip with an antireflection film, it is possible to reduce the optical loss when light is incident on or emitted from the chip. In the first embodiment, the optical characteristics of the chipped wavelength conversion element 33 are further evaluated.

Next, in the first embodiment, the wavelength conversion element 33 manufactured by the above steps is fixed to the upper surface of the upper member 27. At this time, as illustrated in FIG. 3, the adhesive sheet 35 is inserted between the substrate 32 of the wavelength conversion element 33 and the upper surface of the upper member 27, and is pressurized and heated to adhere the substrate 32 and the upper member 27 to each other. Such adhesion is a known bonding method for conductive adhesives. Then, after being fixed on the upper member 27, the upper member 27, the bottom member 28A, and the temperature control element 26 between the upper member 27 and the bottom member 28A are inserted into the inside of the cover member 28B in a state where the upper surface is open, and are stored after being fixed. After the fixing, the upper surface of the cover member 28B of the metal housing 28 and the peripheral side surfaces are seam welded in the atmosphere of the dry gas 302 to hermetically seal the metal housing 28.

### Second Embodiment

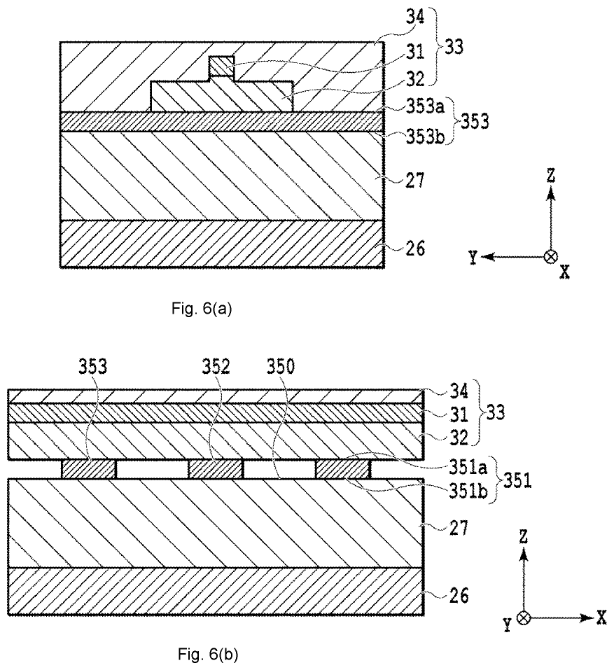

Next, a second embodiment will be described. Since a perspective view of a wavelength conversion device of the second embodiment is similar to the configuration illustrated in FIG. 2 described in the first embodiment, illustration and description thereof will be omitted. FIG. 6 (a) is a schematic cross-sectional view of the wavelength conversion element 33, the adhesive sheet 35, the upper member 27, and the temperature control element 26 of the second embodiment illustrated in FIG. 2 taken along the y-z plane in the drawing. FIG. 6 (b) is a schematic cross-sectional view of the wavelength conversion element 33, the adhesive sheet 35, the upper member 27, and the temperature control element 26 illustrated in FIG. 2 taken along the x-z plane. The second embodiment is different from the first embodiment in that a non-formation region 350 in which an adhesive sheet is not formed is formed between the substrate 32 and the upper member 27 instead of the adhesive sheet 35 of the first embodiment. The non-formation region corresponds to a resin layer non-formation region of the second embodiment.

That is, the second embodiment includes a plurality of adhesive sheets 351, 352, and 353 having an area smaller than that of the adhesive sheet 35 of the first embodiment, and adheres the substrate 32 and the upper member 27 to each other. With this configuration, the non-formation region 350 in which the adhesive sheet is not formed is formed on both sides of the adhesive sheets 351, 352, and 353. As illustrated in FIGS. 6 (a) and 6 (b), the adhesive sheets 351, 352, and 353 all are similar in length in the y direction to the adhesive sheet, but are shorter in length in the x direction than the adhesive sheet 35. Such adhesive sheets 351, 352, and 353 are disposed in a stripe shape on the upper surface of the upper member 27. In the second embodiment as well, a surface 351a of the adhesive sheet 351 facing the substrate 32 adheres to the substrate 32, and a surface 351b of the adhesive sheet 351 facing the upper member 27 adheres to the upper member 27. Note that, although not illustrated, in the adhesive sheets 352 and 353 as well, a surface thereof facing the substrate 32 and a surface thereof facing the upper member 27 adhere to opposing surfaces.

The adhesive sheet can be processed into an arbitrary size and shape by punching or laser processing. Therefore, in addition to adhering the entire surface of the substrate 32 described in the first embodiment, the substrate 32 and the upper member 27 can be partially adhered. According to such a configuration, it is possible to selectively adjust the temperature of only a part of the wavelength conversion element 33. At present, it is known that a temperature distribution exists inside the wavelength conversion element 33 during operation. Specifically, the temperature in the vicinity of the light input port and the temperature in the vicinity of the light output port of the optical waveguide core 31 are higher than those in other portions.

This is considered to be because light absorption occurs when high-power light is input at the input port, and the temperature increases due to the heat relaxation process. In addition, since high-energy light having a short wavelength by wavelength conversion is generated at the output port, it is considered that heat relaxation associated with material absorption occurs and the temperature increases. The second embodiment is effective in selectively adjusting the temperature of a part of the wavelength conversion element 33 and suppressing the temperature distribution in the optical waveguide. When the temperature is selectively adjusted, a higher effect can be obtained by introducing the dry gas 302 into the metal housing 28 and installing the wavelength conversion element 33 in the atmosphere.

### REFERENCE SIGNS LIST

1a Signal light
30 Conversion output signal light
14 Multiplexer
15 Demultiplexer
26, 260 Temperature control element
27, 100, 270 Upper member
28, 290 Metal housing
28A, 280 Bottom member
28B Cover member
30, 200 Wavelength conversion device
31, 310 Optical waveguide core
32, 320 Substrate
33, 330 Wavelength conversion element
34, 340 Overcladding layer
35, 300, 351, 352, 353 Adhesive sheet
35a, 35b, 351a, 351b Surface
311 Core substrate
400 Input port
401 Output port
350 Non-formation region

1. A wavelength conversion device comprising:
a wavelength conversion element that receives excitation light and signal light and outputs wavelength-converted conversion output signal light;
a temperature control unit that controls a temperature of the wavelength conversion element;
a heat transfer member that is provided between the wavelength conversion element and the temperature control unit and transfers heat between the temperature control unit and the wavelength conversion element; and
a sheet-like resin layer provided between the wavelength conversion element and the heat transfer member,
wherein at least a part of the sheet-like resin layer has a surface facing the wavelength conversion element adhered to the wavelength conversion element, and a surface facing the heat transfer member adhere to the heat transfer member.

2. The wavelength conversion device according to claim 1, wherein a length of the sheet-like resin layer from the wavelength conversion element toward the heat transfer member is 10 μm or more and 200 μm or less.

3. The wavelength conversion device according to claim 1, wherein a resin layer non-formation region where the sheet-like resin layer is not formed is formed between the wavelength conversion element and the heat transfer member.

4. The wavelength conversion device according to claim 1, wherein the sheet-like resin layer contains at least one of an epoxy resin and a polyimide resin as a material.

5. The wavelength conversion device according to claim 1, wherein the wavelength conversion element contains any one of LiNbO3, LiTaO3, or LiNb(x)Ta(1−x)O3 (0≤x≤1), or at least one selected from the group consisting of Mg, Zn, Sc, and In as an additive to LiNbO3, LiTaO3, and LiNb(x)Ta(1−x)O3.

6. The wavelength conversion device according to claim 1, wherein the wavelength conversion element is an optical waveguide type wavelength conversion element including an optical waveguide, and polarization is periodically inverted.

7. The wavelength conversion device according to claim 1, further comprising:
an optical fiber that derives the conversion output signal light; and
a selective transmission/reflection unit that is provided between the wavelength conversion element and the optical fiber, transmits one of the excitation light and the conversion output signal light, and reflects the other of the excitation light and the conversion output signal light,
wherein the selective transmission/reflection unit optically connects the conversion output signal light that has been transmitted or reflected to the optical fiber.

8. A method for manufacturing a wavelength conversion device including a wavelength conversion element, the method comprising:
a step of inserting a sheet-like resin layer between the wavelength conversion element and a heat transfer member that transfers heat of a temperature control unit that controls a temperature of the wavelength conversion element to the wavelength conversion element;
a step of pressurizing and curing the sheet-like resin layer to adhere the wavelength conversion element and the heat transfer member to each other;
a step of housing the wavelength conversion element and the heat transfer member adhered to each other in a housing that is partially open, and inserting the temperature control unit between a bottom member of the housing and the heat transfer member; and
a step of sealing an opening portion of the housing.
